(19) United States
(12) Patent Application Publication
(10) Pub. No.: US 2006/0221519 A1
(43) Pub. Date: Oct. 5, 2006

(54) Ground fault circuit interrupter

(75) Inventor: Wen-Ho Yang, Taipei Hsien (TW)

Correspondence Address: BACON & THOMAS, PLLC, 625 SLATERS LANE, FOURTH FLOOR, ALEXANDRIA, VA, 22314, US

(73) Assignee: Sun Lite Sockets Industry Inc., Taoyuan Hsien (TW)

(21) Appl. No.: 11/098,379

(22) Filed: Apr. 5, 2005

(51) Int. Cl. H02H 3/00

(52) U.S. Cl. 361/42

(57) ABSTRACT

An ground fault circuit interrupter includes two conductive wires, an AC-DC converter, a switch circuit, two annular magnets each having a induction coil, a signal treating and controlling circuit, a manual switch driving circuit, and an electronic switch driving circuit. The switch circuit is connected in series with the conductive wires for cutting off power to the output terminals of the conductive wires. The signal treating and controlling circuit electrified by the AC-DC converter receives signals from the conductive wires and sends out its controlled signal. The connecting point of the input of the switch circuit and the output of the signal treating and controlling circuit is connected in parallel with a manual switch driving circuit and an electronic switch driving circuit, for keeping safety of the electricity between the input of power and the output or a load.

### BACKGROUND OF THE INVENTION

1. Field of the Invention

This invention relates to a ground fault circuit interrupter, particularly to one applicable to an emergency circuit protecting circuit device.

2. Description of the Prior Art

In order to enhance safety for using electric appliances or equipment, a lot of research for developing circuit-protecting devices have been made, such as U.S. Pat. No. 3,973,171 and No. 4,568,997, wherein disclose a differential transformer for detecting current imbalance of a circuit.

Next, another U.S. Pat. No. 5,680,287 discloses a kind of circuit protecting device for unbalanced loading but not leading to nuisance tripping.

At present an available leakage switch includes a leakage testing circuit, a switch circuit, a current testing circuit, a DC-AC converter, and a control circuit, but it has a drawback of a complicated circuit, redundant electronic components and a large dimensions. Its power socket consists of a housing provided with an insert pin and power terminals, and after the power terminals are connected with power and the plug of an electric appliance is inserted in the socket hole, the appliance can be used. But the disadvantage is that if the appliances are too many or too large, an overload may happen to burn off a fuse in the circuit and causing circuit interruption and cutting off of other sockets not overloaded. Thus, only one load of leakage may lead to the leakage switch cut off, affecting other sockets.

### SUMMARY OF THE INVENTION

One purpose of the invention is to offer a ground fault circuit interrupter having a simple structure with a few components as possible and a small size.

Another purpose of the invention is to apply the ground fault circuit interrupter to an electric socket of a small size with a few electronic components.

The ground fault circuit interrupter includes at least two conductive wires, an AC-DC converter, a switch circuit, two annular magnets, two coils, a signal treating and controlling circuit, a manual switch driving circuit, and an electronic switch driving circuit. The switch circuit is connected with the two conductive wires for cutting off output current to output terminal of the conductive wires. The conductive wires respectively pass through the two annular magnets, and the two coils are respectively wound on the two annular magnets. The connecting point of

When the signal treating and controlling circuit electrified by the AC-DC converter outputs a controlled signal after receiving a sensed signal from the first and the second coils.

### BRIEF DESCRIPTION OF DRAWINGS

This invention will be better understood by referring to the accompanying drawings, wherein:

FIG. 1 is a diagram of the circuit of a preferred embodiment of a ground fault circuit interrupter in the present invention;

FIG. 2 is a block chart of the circuit of the ground fault circuit interrupter in the present invention;

FIG. 3 is a perspective view of a plug provided with the ground fault circuit interrupter in the present invention;

FIG. 4 is a perspective view of a socket provided with the ground fault circuit interrupter in the present invention; and,

FIG. 5 is a perspective view of an independent circuit interrupter provided with the ground fault circuit interrupter in the present invention,

### DETAILED DESCRIPTION OF THE PREFERRED EMBODIMENT

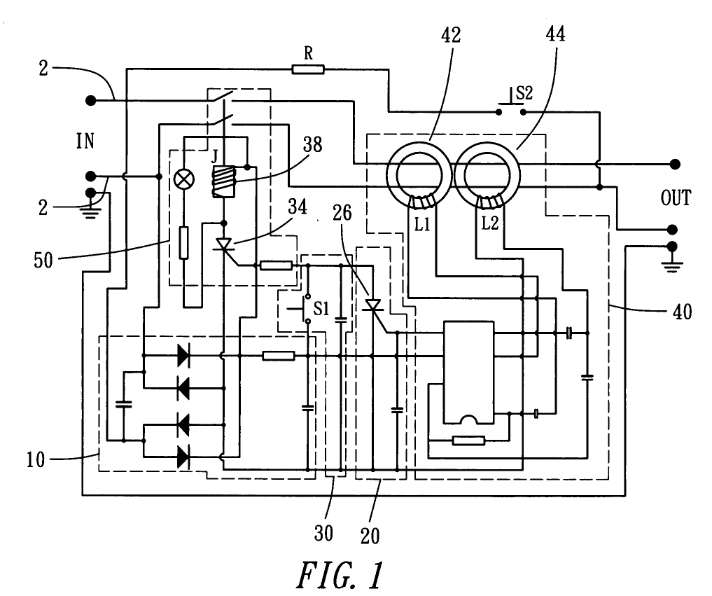

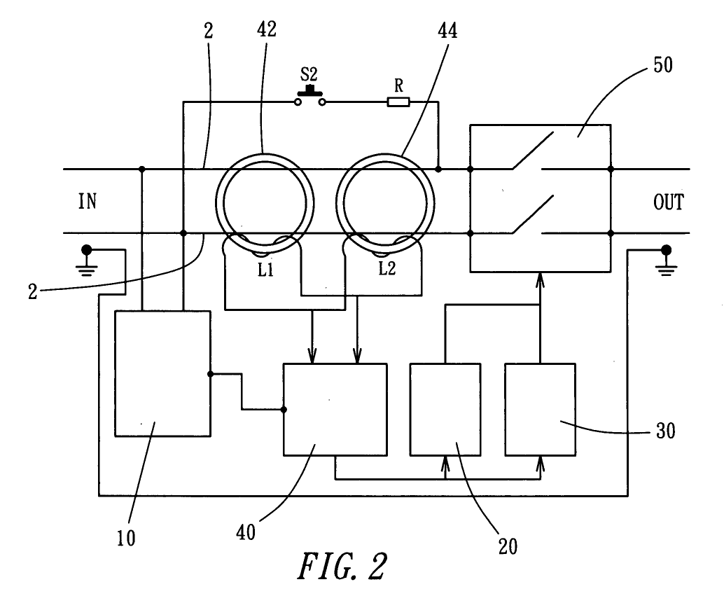

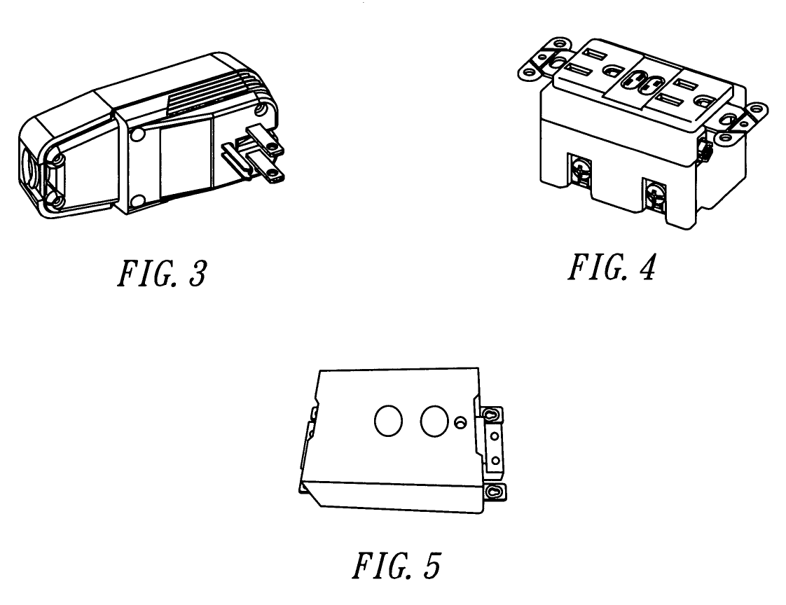

A preferred embodiment of a ground fault circuit interrupter in the present invention, as shown in FIGS. 1 and 2, includes at least two conductive wires 2, a DC-AC converter 10, a switch circuit 50, two annular magnets 42 and 44, a signal treating and controlling circuit 40, and an electronic switch driving circuit 20, as main components connected with one another.

The two conductive wires 2 respectively have one end used as an input terminal (IN) and the other end as an output terminal (OUT), passing through the two annular magnets 42 and 44.

The DC-AC converter 10 is connected with the input terminal of the two conductive wires 2, supplying DC for the interrupter.

The two conductive wires 2 pass through the two (a first and a second) annular magnets 42 and 44, which respectively have a first coil L1 and a second coil L2 wound thereon for outputting induction signals.

The signal treating and controlling circuit 40 gets DC electricity from the AC-DC converter 10, receiving induction signals from the first coil L1 and L2 and then sending out controlled signals.

The input terminal of the switch circuit 50 is electrically connected with the output terminal of the signal treating and controlling circuit 40, and then this connect point is connected in parallel with the manual switch driving circuit 30 and the electronic switch driving circuit 20.

Further, one of the conductive wires 2 is connected in series with a leakage testing key S2 and a resister R.

The switch circuit 50 has a relay coil 38 and a second controlling element 34, which is a SCR.

The manual switch driving circuit 30 is connected in series with a trigger switch S1 at the control terminal of the second control element 34, putting the interrupter in a normally cut-off condition for the safety of the whole circuit.

Moreover, the electronic switch driving circuit 20 is connected in series with the control terminal of the second control element 34, being an SCR to function as a first control element 26, and the control terminal of the first control element 26 is connected with the output control terminal of the signal treating and controlling circuit 40.

In addition, the ground fault circuit interrupter has a grounding member connected with the ground for preventing leakage from causing damage, as shown in the Figures.

It can be understood that the first control element 26 and the second control element 34 can be any electronic elements having controlling function, and SCR is used in this embodiment, with its gate used as the control terminal.

Next, the function of the ground fault circuit interrupter is to be described below. When the AC-DC converter 10 is powered, the load is still in a cut-off condition owing to the relay coil 38 still not electrified. Then the trigger switch S1 is pressed to let current flowing through the second control element 34 (SCR) has its control terminal or the gate getting current through, and then the relay coil 38 is electrified so that the load starts to work.

Should a person touch accidentally the electricity on the load side, current change may cause the two annular magnets 42 and 44 give rise to a feeble voltage alteration, and this signal may pass through the signal treating and controlling circuit 40 to reach the control terminal (gate) of the first controlling element (SCR) 26 so the first control element 26 gets current through, letting the second control element 34 get a minus flat signal owing to the connection of the control terminal of the first and the second control element 26 and 34. Then the second control element 34 may be cut off, causing the relay coil 38 lose current and its magnetism, and subsequently the load is cut off power, preventing both the appliance and the person touching the appliance from getting damaged and hurt.

In general, the working condition of the ground fault circuit interrupter can be described as follows.
1. When the circuit is powered under the non-leaked condition, the output terminal (OUT) cannot directly get the power, and the trigger switch S1 has to be pressed for electrifying the output terminal (OUT).
2. If there is a leakage, the electronic switch driving circuit 20 and the relay coil 38 functions to cut off the power to the output terminal (OUT). When the leakage is corrected, a user has to press the trigger switch S1, or the output terminal (OUT) cannot cut off the power to the output terminal (OUT). When the leakage is corrected, a user has to press the trigger switch S1, or the output terminal (OUT) cannot be powered to let the load work.
3. The press switch S2 provided for testing leakage in the ground fault circuit interrupter can be used periodically by a user according to using conditions for preventing persons from touching and getting electric shock to be hurt or burned to death.
4. In case that the ground fault circuit interrupter is cut off of itself or by power stoppage by the power company, and a user thinks the general power switch is cut off, a person never receives electric shock even if the person repairs or uses an appliance at the output terminal (OUT).

As for application of the ground fault circuit interrupter, it can be used in a plug as shown in FIG. 1, and in a socket as shown in FIG. 4, or as an independent interrupter as shown in FIG. 5 for use between the power and a load. Besides it can be used in any electric appliance or device, having high values for prevention of accidents.

While the preferred embodiment of the invention has been described above, it will be recognized and understood that various modifications may be made therein and the appended claims are intended to cover all such modifications that may fall within the spirit and

What is claimed is:

1. A ground fault circuit interrupter comprising:
at least two conductive wires having a common input terminal and respectively an output terminal;
an AC-DC converter connected electrically with said input terminal of said two conductive wires, said AC-DC converter supplying DC to related circuits;
a switch circuit electrically connected in series with said two conductive wires for cutting off output current to said output terminals of said two conductive wires;
a first annular magnet and a second annular magnet respectively for said two conductive wires to pass through to get inductive current, a first coil and a second coil respectively wound on said two annular magnets for sensing an inductive signal and sending out the inductive signal to said output terminal;
a signal treating and controlling circuit getting DC from said AC-DC converter and receiving the inductive signals from said first coil and said second coil and then outputting its controlled signal;
the connecting point of the input terminal of said switch circuit and an output-controlling terminal of said signal treating and controlling circuit connected in parallel with a manual switch driving circuit for electrifying said switch circuit and an electronic switch driving circuit.

2. The ground fault circuit interrupter as claimed in claim 1, wherein said switch circuit has a relay circuit and an SCR used as a second control element.

3. The ground fault circuit interrupter as claimed in claim 1, said manual switch driving circuit is a trigger switch electrically connected in series with a control terminal of said second control element for manually handled to electrify the whole circuit of said ground fault circuit interrupter in a normally open condition so as to keep the safety of said interrupter.

4. The ground fault circuit interrupter as claimed in claim 1, wherein said electronic switch driving circuit is an SCR connected electrically in series with said second control element, functioning as a first control element, which its control terminal electrically connected with the output control terminal of said signal treating and controlling circuit.

5. The ground fault circuit interrupter as claimed in claim 1, wherein one of said two conductive wires passing through said first annular magnet and said second annular magnet is electrically connected in series with a leakage testing key and a resister.
